(19) United States
(12) Patent Application Publication
(10) Pub. No.: US 2006/0175492 A1
(43) Pub. Date: Aug. 10, 2006

(54) Mounting system

(76) Inventor: Ronald Chadwick Cooper, Wyckoff, NJ (US)

Correspondence Address: W Patrick Quast, 164 Franklin Turnpike, P O Box 444, Waldwick, NJ, 07463, US

(21) Appl. No.: 10/538,321

(22) PCT Filed: Dec. 17, 2003
(86) PCT No.: PCT/US03/40434

§ 371 Date: Jun. 10, 2005

Related U.S. Application Data
(60) Provisional application No. 60/434,043, filed on Dec. 17, 2002.

(51) Int. Cl. G09F 7/18; A47B 96/06

(52) U.S. Cl. 248/229.17

(57) ABSTRACT

A two piece (20, 22) mounting system is disclosed. For a marine application, as, for example, mounting a pair of air tanks (10, 12) together, a first piece (20) is attached to one tank and a second piece (22) is attached to the other tank. A pair of cooperatively dimensioned cavities (48, 84) and protrusions (54, 90) on the front of both pieces permit easy and rapid mounting of the first piece to the second piece. A built-in spring loaded, indexing plunger mechanism (72) automatically locks the two pieces together at an automatically predetermined positioned dictated by the length of one protrusion and a built-in stop (112) in a cavity. Quick dismounting is permitted by simply displacing the handle (208) on the plunger mechanism. A number of other applications, including mounting a fire extinguisher to a wall, is discussed.

This design relates to a mounting system and particularly to a system which permits the quick mounting and dismounting of the items to the bearing surface or element.

### BACKGROUND

There are many items in different applications, whose usage would be facilitated if there would be an ability to quickly and easily mount and dismount them.

In marine situations, for example, boaters and scuba divers are aware of the benefits of being able to mount and dismount items quickly and conveniently. Some items include anchors, electronic gear, fire extinguishers, dive ladders, scuba cylinders and others.

In other environments as well, the benefits of a quick, easy and secure mounting assembly are apparent. So, for example, the need for a quick, but secure remounting of fire extinguishers under such conditions as earthquakes, auto/truck accidents, difficult fire scenarios, or other extreme conditions, is of obvious benefit.

In the marine area, it is important for boaters to be able to remove vulnerable, expensive electronic gear whenever they leave their vessel at the end of the day or for an extended time. The boat's anchor preferably should be kept off the vessel's fragile decks. If it could be detachably secured, perhaps to the boat's railing, this concern can be obviated. Of course, these efforts should present minimum inconvenience.

The impetus for the present invention came from the inventor's interest in scuba diving. Scuba divers realize the need for a quick, relatively easy and secure connect/disconnect system. They are faced with mounting or detaching their buoyancy compensator (B.C.) to their main oxygen tank; and their, smaller back-up air tank(s) (pony bottle) to the primary tank. Many times these chores are performed on board as the vessel rolls, or along a rocky coast where the footing is a challenge.

A further consideration beyond the practicality of such a system is its cost. For example, divers, traditionally, will have at least two tanks of their own. Some will have several, and, typically with different stress demands. For example the coupling between the B.C. and the main tank will differ in size and load bearing capacity from the connection between the main tank and the spare or pony bottle. As a practical matter, divers will own several tanks. So, too, there are different diameter spare tanks on the market.

Preferably, a mounting system should accommodate all of these variables. A simple, secure cost effective way to accomplish this connect/disconnect function is desired. Various approaches have been identified in the prior art.

For example, in U.S. Pat. No. 4,949,889, a design is revealed which relies on a nylon band to secure the spare tank. This band will stretch when heated or moistened allowing for some play and possibly loss of the spare tank. Newer buoyancy compensators use two nylon bands to secure the pony bottle to the main tank, in case one should loosen. This device further places the spare tank in an uncomfortable position if placed on one of the two bands of a newer buoyancy compensator. The tightening of these bands is crucial but difficult. With one unit hanging from one of the bands it is extremely difficult to complete the process. Furthermore, removal of the spare tank underwater would be very time consuming and difficult.

U.S. Pat. No. 5,906,302 reveals a design that is very difficult and time consuming to attach. The diver must separate the tank band from its buckle, then feed it through this device and then back to and through the buckle. This must be done while supporting a tank, anywhere in the range of 8 to 15 lbs (3.5 70 7.0 kilo), on the deck of a pitching boat. Also if the diver decides to change the size of the spare tank, a differently sized device would have to be employed. Further, the removal of the spare tank underwater would be very time consuming and difficult.

U.S. Pat. No. 5,887,836 reveals a device that uses two detent pins. The disclosed detent pins require jiggling and extreme pressure to push in or remove, especially while wearing a thick, diver's glove. These pins are secured from dropping by steel cables. These cables form loops that can easily be snagged by fishing line, hooks or wreckage. If this should happen these detent pins could be pulled free, or at least create a panic situation. These cables often fray, allowing a strand to penetrate the crucial air bladder located in the buoyancy compensator. Again, if the diver should want to change the diameter of the tank, an additional, differently sized unit would have to be purchased. Still further, the use of a nylon strap (Col. 3, 1.56) again is problematic due to heat and moisture. The inventor's experience with this device leads him to conclude that the alignment or attachment of this device requires some practice, especially on the deck of a boat out at sea. This item is very costly due to its construction process.

The device described in U.S. Pat. No. 6,367,753 requires a great amount of strength to manipulate. The slotted opening created for the stainless steel banding appears to allow these bands much space to move. Judging from its description it appears it uses a flat surface to press against the round outside diameter of the spare air tank. Even though this device was designed to connect two cylinders, there are no rounded surfaces at all. This will create excessive wear on the aluminum tanks that are filled with 3000 psi (210 bar) of air. There are many sharp edges and protrusions that can be easily snagged, or puncture dive gear.

The design of U.S. Pat. No. 5,390,886 uses two of its described pieces to secure, a 30 cu ft (0.85 cu meters) tank, the most common size. When using these two pieces the diver has a problem keeping them aligned so the tank can be installed. They are usually knocked from alignment when being hit or bumped in the car, at the dive shop or on the boat. This means the hose clamps have to be loosened, realigned and tightened. Often this realignment will be performed out at sea. Another problem is the use of two detent pins. They are hard to place and remove. They are attached by a steel cable, so that when the pin is pushed into place, the cable forms a loop that is easily snagged by fishing line, hooks or wreckage. Not only will this panic a diver, the detent pin may be pulled free, allowing the spare tank to separate. Once again, these cables are known to fray, allowing its strands to puncture the air bladder in the buoyancy compensator.

The device described in design patent, DES. 342,666 uses a pin that may easily be lost. It is designed to connect two round cylinders, yet there are no rounded contact surfaces. This will create uneven wear on a potentially explosive tank. As with several of the designs discussed, this design would appear to be very costly to create. This inhibits the diver from buying multiple sets of the mounting assembly. This reduces the tank transfer time and reduces the pleasure and/or productivity of a diving experience.

It is therefore a principal object of the present invention to provide a two piece mounting system, wherein one piece slides quickly and easily into another and wherein an integral locking mechanism between the two pieces is automatically engaged.

It is a further object of the invention to provide a two piece mounting system wherein each piece is fabricated from extruded metal thus lessening their cost and availability in multiple sets.

It is a further object of the present invention to provide a locking mechanism for the two piece mounting system which is easily disengaged from the locked position.

It is yet another object to provide a locking mechanism which does not require cables to secure it as part of the mounting system thus avoiding snagging and interference problems.

It is still another object of the invention to provide a two piece mounting system wherein the sliding movement of the first piece into the second is purposely stopped at a support surface of the second near the point of locking mechanism engagement and disengagement, so as to facilitate the attachment and detachment of the item to be mounted.

It is but another object of this invention to provide a two piece mounting system, wherein each piece includes arcuate contact surfaces for engaging, simultaneously cylindrical members, for example, the main tank and pony bottle of a scuba diver's equipment.

It is still another object of this invention to provide a two piece mounting system which is configured to minimize drag, for example, as part of a scuba diver's equipment, while used in the water; and which is further shaped to minimize interference contacts with the surrounding environment.

It is still yet another object of this invention to provide an interface mounting arrangement between the two piece mounting system and the equipment secured by the mounting system, which is secure under all possible orientations of the system-equipment, as employed.

### SUMMARY

These and other objects are obtained with the mounting system of the present invention.

As noted above there are many situations where it is important if not vital to have a quick connect/disconnect system for various items. Especially in a marine environment, and even more particularly for scuba divers, reliable systems of this type are essential. It occurred that having these systems in place, attached to the items to be mounted together, would be an advantage. Further, if an operator's simple arm movements effectuate a secure, reliable connection and disconnection the result would be an important improvement.

To this end a two piece mounting system incorporating these ideas is devised. For mounting a main air tank used in scuba diving to a pony air tank, for example, two similar pieces would be employed. Each would have a generally rectangularly shaped central body portion that is preferably fabricated in extruded aluminum, but can, of course, be made of other metals such as steel, and a variety of plastic materials. Each of the two pieces can have a partially arcuate rear surface matching the radii of tanks for attachment. Connection to the tanks can be made in any convenient manner, in this case stainless steel band-clamps being preferred. The first piece can be connected to the pony air tank, and the second piece to the main air tank. The front of the first piece has an attached generally cylindrical protrusion extending from the top of the piece a spaced distance down one side of the central body, with a matching cylindrical cavity being formed into the other side of the central body. A similar matching and cooperating structure is incorporated into the front of the second piece.

To provide the fast and automatic connection and easy disconnection required by the present invention, the cavity in the first piece is equipped with a spring loaded, indexing plunger mechanism which will be fully illustrated and described below. For the second piece the top of the cylinder has a beveled edge, with an indent in the cylinder positioned just below this edge. The base of the cylinder cavity has a plug of a specific dimension. To securely mount the pony air tank to the main air tank, an operator simply raises the first piece over the second piece and lowers the matching cylinder-cavities together. The precise dimensions of the cylinder on the first piece, together with the plug in the matching cavity in the second piece insure that the spring biased plunger portion in the plunger mechanism, which has been urged inwards by the beveled top surface of the cylinder in the second piece, is in axial alignment with, and in fact is positioned into, the indent adjacent the top of the second piece cylinder. The two tanks are now secured together reliably for any future orientation. For quick release, the handle on the plunger mechanism is simply pulled out against the biasing spring permitting the two pieces to be separated.

As previously discussed and to be more fully described below, the basic mounting system can be employed for a wider variety of applications. The rear surface of one or both pieces can be fabricated to accommodate flat or variously curved surfaces. The overall dimensions of either piece can obviously be selected for the given application.

### BRIEF DESCRIPTION OF THE DRAWINGS

FIG. 1 is a side elevation view of the invention as used to secure oxygen tanks to a buoyancy compensator used in scuba diving.

FIG. 2 is a top plan view of FIG. 1, with the so-called pony-tank rotated 90°, in the direction of the arrow, from its position in FIG. 1.

FIG. 3 is a perspective view of a first piece of a first adaptation of the present invention.

FIG. 4 is a perspective view of a second piece of the first adaptation of the present invention.

FIG. 5 is a perspective view of a first piece of a second adaptation of the present invention.

FIG. 6 is a perspective view of a second piece of a second adaptation of the present invention.

FIG. 7 is a perspective view of the first piece of the second adaptation of the invention as depicted in FIG. 5, shown mounted to a buoyancy compensator for a scuba diving application of the present invention.

FIG. 8 is a perspective view shown to understand the relationship between the first and second pieces of the first adaptation for the present invention, prior to their connection.

FIG. 9A is a perspective view of a second piece of yet another adaptation of the present invention.

FIG. 9B is a top plan view of the second piece depicted in FIG. 9A.

FIG. 10A is a side elevation view of another application of the present invention.

FIG. 10B is a top plan view of the application depicted in FIG. 10A taken along lines 10B-10B in FIG. 10A.

### DESCRIPTION OF THE PREFERRED EMBODIMENTS

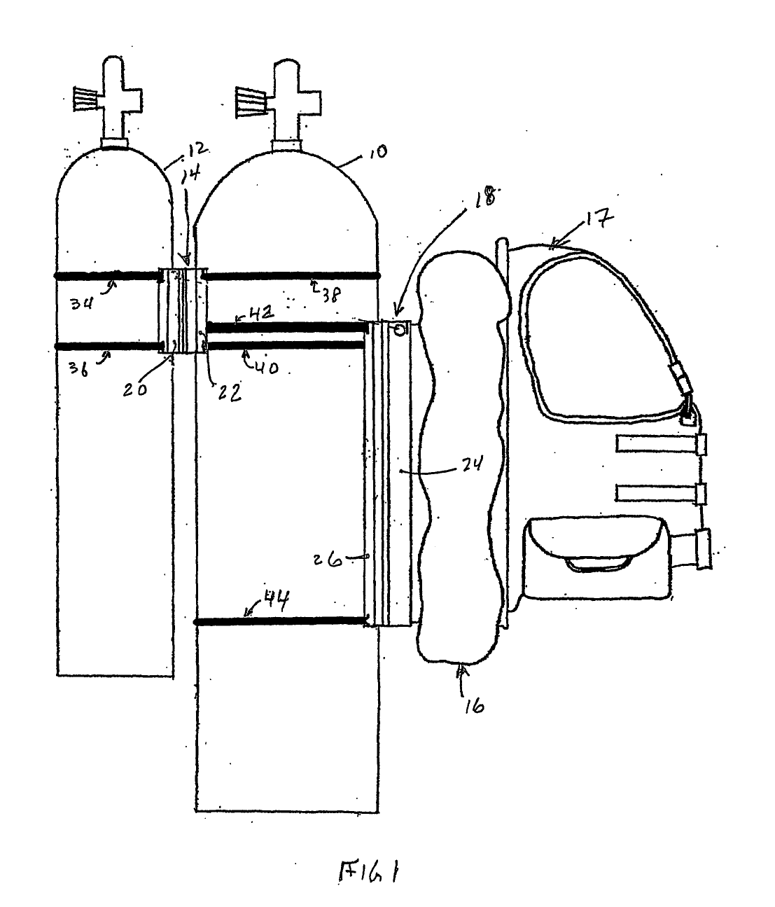

Refer now to the drawings. The use of the same reference numerals in different figures signify one and the same item. Various preferred embodiments of the mounting system of the present invention are shown. In FIG. 1, in one application of the invention, it is seen as applied to securing a main oxygen tank 10 to a smaller reserve tank, or pony tank, 12 through a first adaptation of the invention 14; and the mounting of that combination to a buoyancy compensator (BC) 16 attached to a scuba diver's vest 17, using a second adaptation of the invention 18.

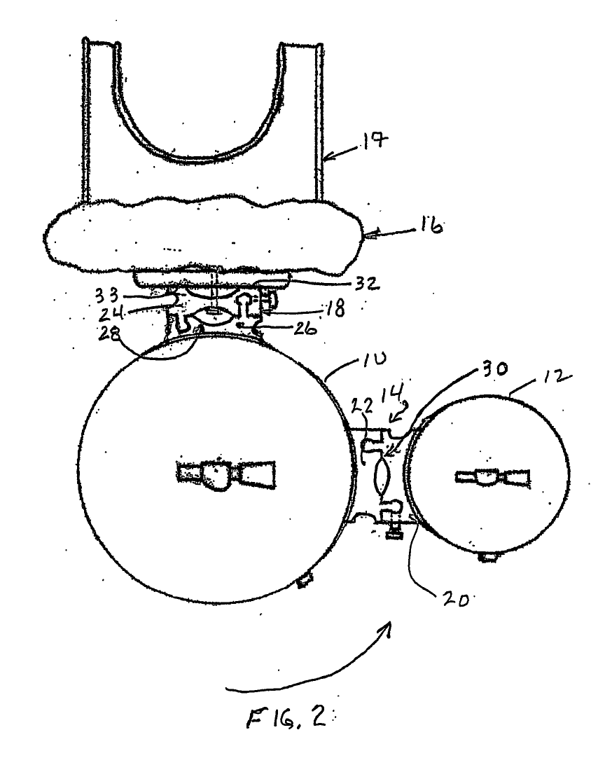

The first adaptation 14 includes a first and second piece, 20 and 22. The second adaptation 18 includes a first and second piece 24 and 26. The two adaptations differ in length and other minor aspects as will be apparent from the following discussion. Adaptation 18 is longer due to the fact that it must balance the weight of the tank combination along the length of the mounting surface associated with the BC. From FIG. 2, it is seen that the interface boundaries 28 and 30 for each of the two adaptations are substantially identical in profile. In this application, the mounting surfaces 32 and 33 of piece 24 are flat so as to complement the mounting surface of the BC.

To secure the cylindrical tanks 10 and 12 to the first adaptation 14, adjustable band-clamps 34 and 36, and 38 and 40 are used. These typically are stainless steel band-clamps identical to the radiator hose clamps purchased at auto parts stores. The relationship between each of these band-clamps and the pieces 20 and 22, will be discussed hereinafter. A further set of band-clamps 42 and 44 are used to connect the combined tanks to the second piece 26 of the second adaptation 18.

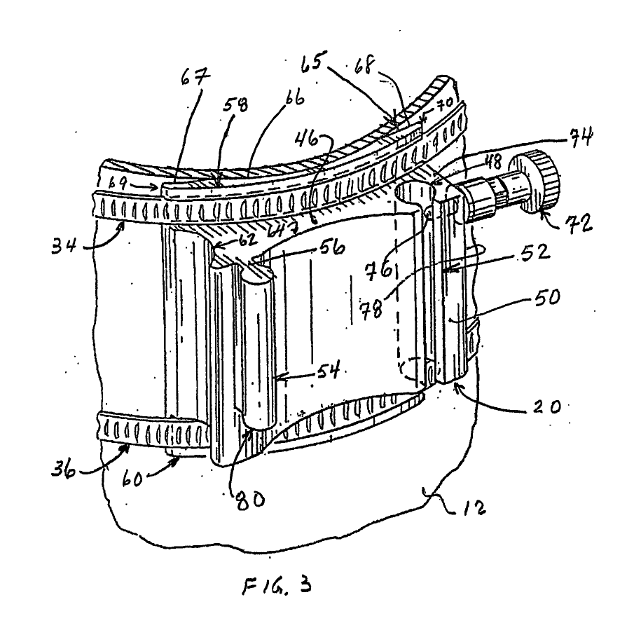

FIG. 3 depicts the first piece 20 shown secured to an air tank 12 by band-clamps 34 and 36. The piece 20, as is true with the other pieces that form the adaptations, 14 and 18, as well as the adaptations for the other embodiments, all of which will be described hereinafter, is fabricated from a material suitable for its environment of use as well as having the necessary strength requirements. So, for example, in its utilization in a scuba diver environment, the piece is fabricated from aluminum or plastic so as to resist the corrosive effects of water, keeping in mind as well, the need to provide a piece that is relatively light weight and which will only minimally contribute to drag while in use in the water.

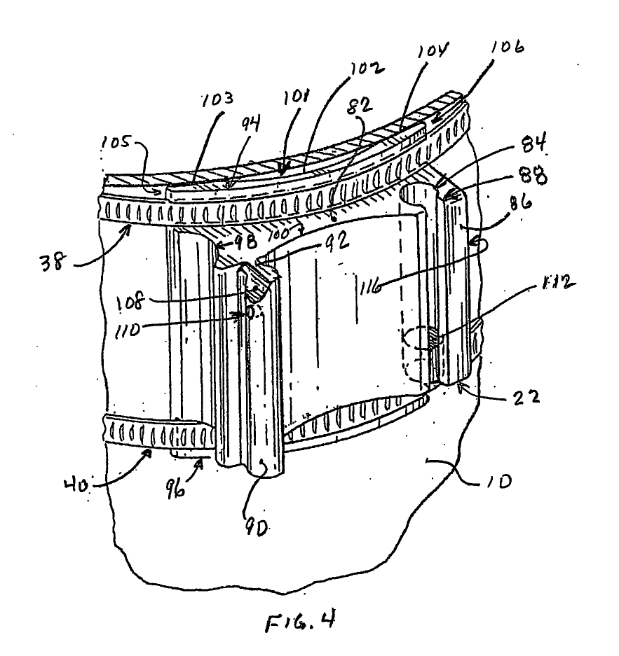

Individual pieces, 20 and 22, are initially cut from an extruded aluminum piece which has the basic shape necessary to implement the interconnect feature of the present invention. The individual pieces are cut at appropriate lengths to accommodate the application. So for example, for the scuba diver application, for the pieces depicted in FIG. 3 and FIG. 4, which, together, implement the first adaptation 14, the longitudinal length would be approximately 4″ (10 cm). The individual, basic pieces are cut to the desired length from the extended, extruded piece. They are then subsequently machined to provide the surfaces and features necessary to fully implement the invention and which may be unique to a specific application. This approach reduces production costs significantly.

In FIG. 3, the cut first piece, as extruded, is seen to include a first central body portion 46. Formed at one lateral end is a cavity 48 which is interiorly disposed in the first central body portion. This cavity is partially circular. The cavity 48 is interconnected along its longitudinal length to and through the surface 50 of the central body portion 46, via a rectangular cutout 52. Formed at the other lateral end by the extrusion is a first, partially circular protrusion 54 extending outward from the first central body portion 46 and connected thereto by extension member 56. The contours of 54 and 56, and their respective dimensions and dimensional relationship to the first central body portion, complement the contours of cavity 48 and cutout 52, and their dimensions, and dimensional relationships to the first central body portion, for purposes which will be apparent hereinafter.

Extending longitudinally, axially, in both directions from the first central body portion 46, are band-clamp retention portions 58 and 60. Each of the associated facing surfaces are machined to form a retaining groove which is dimensioned to accommodate the longitudinal width and thickness of the securing band portions of the band-clamp, such as 34 and 36. This prevents the respective band from slipping off from the piece 20 secured to a tank 12, when in use in difficult environments.

Arcuate segments 62 and 64 are also formed in the basic extruded piece. These segments are designed into the extruding mold so as to eliminate unnecessary material from the piece-a benefit in scuba diving applications in that it reduces the weight of the pieces 20 and 22, and helps to minimize drag in the water.

The rear surface 65 of the piece 20 is formed having partially arcuate surfaces of predetermined radii, if the piece is to be secured to a cylindrical object such as an air tank. So for example, surface portion 66 of rear surface 65 as formed extends the entire longitudinal length and has a first radius which complements the radius of the outer surface of the smaller cylindrical air tank, 12. The piece 20 is formed such that surface portions 67 and 68 at the lateral edges, 69 and 70, have the same radius, which complements the radius of the outer surface of the larger cylindrical tank, 10. The piece 20 is shown in FIG. 3 as secured to the smaller cylindrical tank 12 along surface portion 66.

Piece 20 is further machined to permit the mounting of a spring-loaded, indexing plunger mechanism, 72. This includes forming a threaded opening through the side wall 74 which forms part of the partially circular cavity 48. The spring biased plunger portion 76 of the mechanism 72 protrudes into the cavity 48 when the mechanism 72 is firmly secured against the outer surface 78 of the piece 20. The components that form the mechanism 72 are fabricated from materials that are compatible with the anticipated environment for a given application. So for example when used as part of the scuba diving equipment, the metallic parts of the mechanism 72 would typically be manufactured from stainless steel. One suitable plunger mechanism is supplied by J. W. Winco, Inc., located in New Berlin, Wis., under their part number GN 617-6-NI.

As best seen in FIG. 3, the first partially circular protrusion 54 and its associated extension 56 are machined so as to trim their length at its bottom end 80. This is done for reasons that will be apparent from the discussion hereinafter.

FIG. 4 depicts piece 22 which cooperates with piece 20 to form the first adaptation of the invention 14. As noted above, the piece 22 is first cut to the desired length from the basic formed aluminum extrusion. Again, for a scuba diving tank application, this length would be approximately 4″ (10 cm). Once cut the piece 22 is machined to provide the surfaces and features necessary to implement the invention of the specific adaptation.

In FIG. 4, the piece 22, as extruded, is seen to include a second central body portion 82. Formed at one lateral end is a cavity 84 which is interiorly disposed in the second central body portion. This cavity is partially circular. The cavity 84 is interconnected along its longitudinal length to and through the surface 86 of the central body portion 82, via a rectangular cutout 88. Formed at the other lateral end by the extrusion is a first, partially circular protrusion 90 extending outward from the second central body portion 82 and connected thereto by extension member 92. The contours of 90 and 92, and their respective dimensions and dimensional relationship to the second central body portion, complement the contours of cavity 84 and cutout 88, and their dimensions, and dimensional relationships to the second central body portion, for purposes which will be apparent hereinafter.

Extending longitudinally, axially, in both directions from the second central body portion 82, are band-clamp retention portions 94 and 96. Each of the associated facing surfaces are machined to form a retaining groove which is dimensioned to accommodate the longitudinal width and thickness of the securing band portions of the band-clamp, such as 38 and 40. This prevents the respective band from slipping off from the piece 22 secured to a tank 10, when in use in difficult environments.

Arcuate segments 98 and 100 are also formed in the basic extruded piece. These segments are designed into the extruding mold so as to eliminate unnecessary material from the piece, a benefit in scuba diving applications in that it reduces the weight of the pieces 20 and 22, and helps to minimize drag in the water.

The rear surface 101 of the second piece 22 is formed having partially arcuate surfaces of predetermined radii if the piece is to be secured to a cylindrical surface, such as an air tank. So for example, surface portion 102 of rear surface 101 as formed, extends the entire longitudinal length and has a first radius which complements the radius of the outer surface of the smaller cylindrical air tank, 12. The piece 22 is formed such that surface portions 103 and 104 at the lateral edges, 105 and 106, have the same radius which complements the radius of the outer surface of the larger cylindrical tank, 10. The piece 22 is shown in FIG. 4 as secured to the larger cylindrical air tank 10 in contact with surface portions 103 and 104.

Circular protrusion 90 is machined on its top end to form a beveled surface 108. The circular protrusion 90 is further machined to provide a cylindrically shaped indent 110, at a point in the lateral outside surface, just below the bottom of the beveled surface 108.

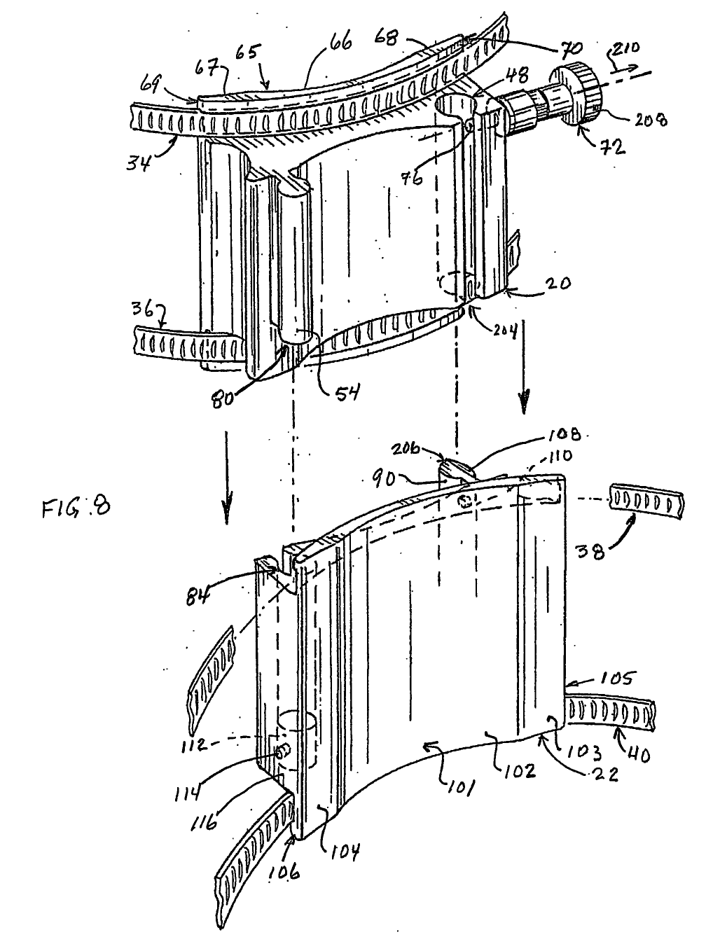

Circular plug 112 is sized to tightly fit at the bottom of cavity 84, as viewed in FIG. 4. It is secured therein via a stainless steel pin 114 (see FIG. 8) which is press-fitted through a compatible opening in the side-wall 116 and into a complementing hole (not seen) in the plug 112.

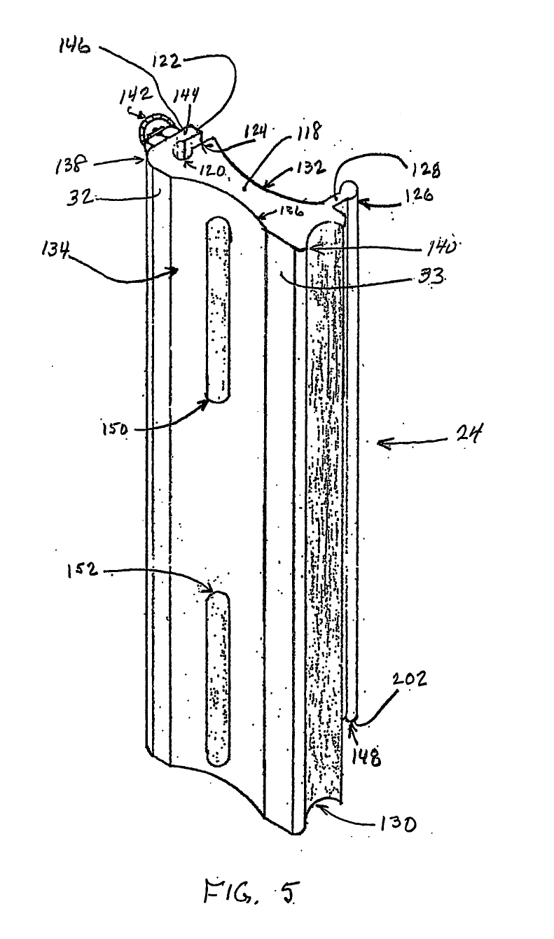

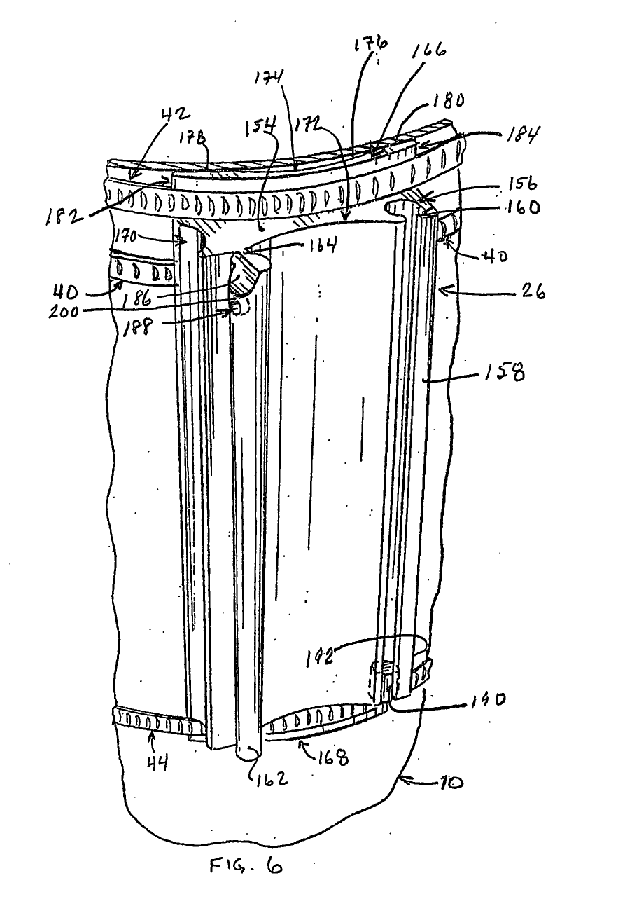

Referring to the second adaptation of the invention, 18, individual pieces, 24 and 26, are initially cut from two separately formed, extruded aluminum pieces, each of which has the basic shape necessary to implement the interconnect feature of the present invention. The individual pieces are cut at appropriate lengths to accommodate the application. So for example, for the scuba diver application, for the pieces depicted in FIGS. 5 and 6, which, together, implement the second adaptation 18, the longitudinal length would be approximately 12″ (30.5 cm). Once the basic pieces are cut to the 12″ (30.5 cm) length requirement, they are subsequently machined to provide the surfaces and features necessary to fully implement the invention and which may be unique to a specific application. As noted above, this approach reduces production costs significantly.

In FIG. 5, the cut first piece 24, as extruded, is seen to include a first central body portion 118. Formed at one lateral end is a cavity 120 which is interiorly disposed in the first central body portion and extends the entire longitudinal length of the piece 24. This cavity is partially circular. The cavity 120 is interconnected along its longitudinal length to and through the surface 122 of the central body portion 118, via a rectangular cutout 124. Formed at the other lateral end by the extrusion is a first, partially circular protrusion 126 extending outward from the first central body portion 118 and connected thereto by extension member 128. The contours of 126 and 128, and their respective dimensions and dimensional relationship to the first central body portion, complement the contours of cavity 120 and cutout 124, and their dimensions, and dimensional relationships to the first central body portion 118, for purposes which will be apparent hereinafter.

Arcuate segments 130 and 132 are also formed in the basic extruded piece. These segments are designed into the extruding mold so as to eliminate unnecessary material from the piece, a benefit in scuba diving applications in that it reduces the weight of the piece 24, and helps to minimize drag in the water.

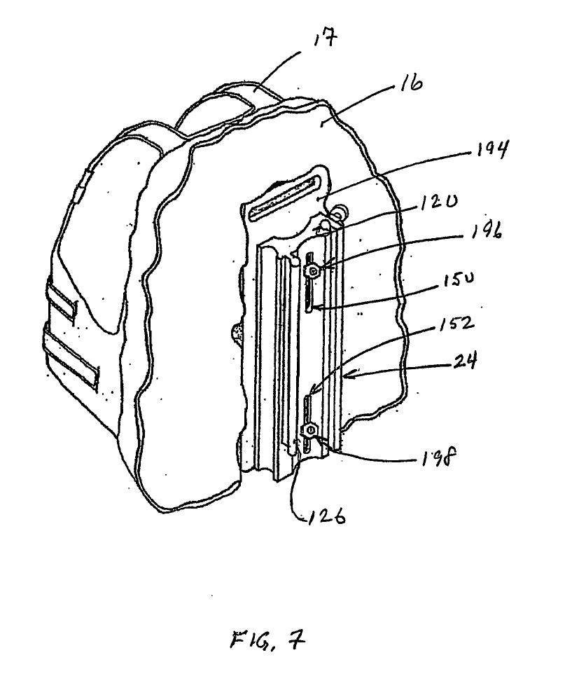

The rear surface 134 of the piece 24 is formed having a partially arcuate surface of predetermined radius for when the piece is to be secured to a cylindrical surface. So for example, surface portion 136 of rear surface 135 as formed, extends the entire longitudinal length and has a first radius which complements the radius of the outer surface of a cylindrical surface such as an air tank. It also reduces weight and minimizes drag in a water environment. The piece 24 is formed such that surface portions 32 and 33 at the lateral edges, 138 and 140, are substantially flat, which allows mounting the piece 24 to a flat surface such as the mounting plate affixed to the buoyancy compensator, 16. (See FIG. 7).

Piece 24 is further machined to permit the mounting of a spring-loaded, indexing plunger mechanism, 142. This includes forming a threaded opening through the side wall 144 which forms part of the partially circular cavity 120. The spring biased plunger (not shown) portion of the mechanism 142 protrudes into the cavity 120 when the mechanism 144 is firmly secured against the outer surface 146 of the piece 24. The components that form the mechanism 142 are fabricated from materials that are compatible with the anticipated environment for a given application. So for example when used as part of the scuba diving equipment, the metallic parts of the mechanism 142 would typically be manufactured from stainless steel. One suitable plunger mechanism is supplied by J. W. Winco, Inc., located in New Berlin, Wis., under their part number GN 617-6-NI.

As seen in FIG. 5, the first partially circular protrusion 126 and its associated extension 128 are machined so as to trim their length at their bottom 148 as viewed in FIG. 5. This is so for reasons that will be apparent from the discussion hereinafter.

The piece 24 is further machined to provide mounting slots 150 and 152. These are machined completely through the first central body portion 118 to facilitate securing the piece 24 to a mounting surface.

FIG. 6 depicts second piece 26 which cooperates with piece 24 to form the second adaptation of the invention 18. The piece 26 is first cut to the desired length from a basic formed aluminum extrusion. The basic extruded piece from which piece 26 is cut, in fact, is identical to the one from which the pieces 20 and 22 are cut. For a scuba diving tank application, where this piece, 26, is used to mate with piece 24, the length would be approximately 12″ (30.5 cm). Once cut the piece 26 is machined to provide the surfaces and features necessary to implement the invention as to the specific adaptation.

In FIG. 6, the piece 26, as extruded, is seen to include a second central body portion 154. Formed at one lateral end is a cavity 156 which is interiorly disposed in the second central body portion. This cavity is partially circular. The cavity 156 is interconnected along its longitudinal length to and through the surface 158 of the central body portion 154, via a rectangular cutout 160. Formed at the other lateral end by the extrusion is a first, partially circular protrusion 162 extending outward from the second central body portion 154 and connected thereto by extension member 164. The contours of 162 and 164, and their respective dimensions and dimensional relationship to the second central body portion, complement the contours of cavity 156 and cutout 160, and their dimensions, and dimensional relationships to the second central body portion 154, for purposes which will be apparent hereinafter.

Extending longitudinally, axially, in both directions from the second central body portion 154, are band-clamp retention portions 166 and 168. Each of the associated facing surfaces are machined to form a retaining groove which is dimensioned to accommodate the longitudinal width and thickness of the securing band portions of the band-clamp, such as 42 and 44. This prevents the respective band from slipping off from the piece 26 secured to a tank 10, when in use in difficult environments.

Arcuate segments 170 and 172 are also formed in the basic extruded piece. These segments are designed into the extruding mold so as to eliminate unnecessary material from the piece, a benefit in scuba diving applications in that it reduces the weight of the piece 26, and helps to minimize drag in the water.

The rear surface 174 of the piece 26 is formed having partially arcuate surfaces of predetermined radii if the piece is to be secured to a cylindrical surface, such as an air tank. So for example, surface portion 176 of rear surface 174 as formed, extends the entire longitudinal length and has a first radius which complements the radius of the outer surface of a smaller cylindrical air tank, such as tank 12. The piece 26 is formed such that surface portions 178 and 180 at the lateral edges, 182 and 184, have the same radius, which complements the radius of the outer surface of a larger cylindrical tank, such as tank 10. The piece 26 is shown in FIG. 6 as secured to the larger cylindrical air tank 10 in contact with surface portions 178 and 180.

Circular protrusion 162 is machined on its top end to form a beveled surface 186. The circular protrusion 162 is further machined to provide a cylindrically shaped indent 188, at a point in the lateral outside surface, just below the end of the beveled surface 186.

Circular plug 190 is sized to tightly fit at the bottom of cavity 156, as viewed in FIG. 6. It is secured therein via a stainless steel pin (not visible) which is press-fitted through a compatible opening in the side-wall 192 and into a complementing hole (again, not seen) in the plug 190.

Referring to FIG. 7, piece 24, such as depicted in detail in FIG. 5, is secured to the mounting plate 194 attached to the buoyancy compensator 16 in a known way. The bolts forming part of the bolt and nut arrangements 196 and 198, are secured to the mounting plate 194. They pass through slots 150 and 152 in the piece 24. Once assembled with the piece 24 in place, the BC is now ready to be connected to a main cylindrical air tank, such as 10 in FIG. 1.

FIG. 8 shows the pre-assembly position of the first piece 20, in place on a cylindrical tank, in relation to the second piece 22 also in place on its respective cylindrical tank. While only the pre-interconnect relationship of the pieces, 20 and 22, comprising the first adaptation of the invention is shown in FIG. 8, the same relative position of piece 24, affixed to the BC as shown in FIG. 7, to its mating piece 26 shown in FIG. 6, would be identical.

Consider first, however, the assembly of the BC with piece 24 affixed, to a main tank, for example 10 in FIG. 1. Piece 26 is attached to the main tank 10 with band-clamps 42 and 44. Piece 22 would already be affixed to the main tank 10 using band-clamps 38 and 40, prior to affixing piece 26 thereto (See FIG. 1). The BC with piece 24 affixed is positioned above the main tank 10 such that the circular portion 126 is axially aligned with the cavity 156 of the second piece 26; and the cavity 120 axially aligned with the circular protrusion 162 of piece 26. The BC with piece 24 attached is lowered down on to piece 26 such that the circular portions of the respective pieces 24 and 26 enter the corresponding cavities 120 and 156. The tolerance of the aligning circular portions and the extensions 128 and 164, and the complementing cavities are sufficiently, loosely dimensioned to permit easy axial engagement.

As the pieces 24 and 26 achieve the fully, interconnected position as shown in FIG. 1, the beveled surface 186 contacts the spring-biased plunger portion of the spring loaded, indexing plunger mechanism 142. This forces the plunger back into the body of the mechanism until the plunger reaches the outside surface 200 of circular portion 160 between the beveled surface 186 and the cylindrically shaped indent 188. With the pieces 24 and 26 fully engaged in their interconnected position, the plunger of mechanism 142 is then axially aligned with the center line of the indent 188 and is urged into that opening by the spring in the mechanism 142. The two pieces are now affirmatively locked together. To facilitate the assembly procedure just described, the circular plug 190 disposed at the bottom of cavity 156 in piece 26 provides a stop for the descending BC with piece 24 attached. The plug 190 contacts the undersurface 202 (see FIG. 5) of the shortened circular portion 126, at the point of interconnection between the pieces 24 and 26 where the spring-biased plunger is axially aligned with the indent 188. The stop also shares the weight distribution of the tanks suspended from the BC with the plunger portion of the mechanism 142.

Now the BC with main tank affixed can be secured to a second tank typically the smaller pony tank, 12. FIG. 8 illustrates this.

Prior to the assembly of the combination of the BC and main tank to the smaller pony tank, piece 20 of the first adaptation is secured to the pony tank 12 using band-clamps 34 and 36. For purposes of clarity, the pony tank 12 is not depicted in FIG. 8. Nor is the main tank shown affixed to the piece 22.

Piece 20 on the pony tank is positioned so that the bottom 204 of the cavity 48 is axially aligned with and positioned above the top surface 206 of circular protrusion 90. Circular protrusion 54 is positioned so as to axially align with the opening of cavity 84. The pony tank with the piece 20 secured thereto is brought in to cooperative relationship with the main piece 22 secured to the main tank by threading the circular protrusion 90 in to the cavity opening 48, while engaging circular portion 54 of piece 20 in cavity 84 in piece 22. As piece 20 moves downward, as viewed in FIG. 8, eventually the beveled surface 108 of protrusion 90 contacts the plunger 76 of indexing plunger mechanism 72. Thereupon, as the piece 20 moves further, downwardly, the plunger 76 is urged further inwardly, until protrusion 76 axially aligns with the cylindrically indent 110 in the lateral outside surface. At this point the plunger is urged by the spring in mechanism 72 into engagement with the indent 110 for positive locking of the two pieces.

Circular plug 112 provides a support for the bottom end 80 of the circular portion 54 just at the point where the plunger 76 engages the cylindrically shaped indent 110. The plug 112 prevents the user from over shooting the point of axial alignment between the plunger 76 and the indent 110, something which could occur readily, due to the weight of the cylinder involved and the difficulty in exactly positioning the two tanks, relatively, at that point of alignment between the plunger and the indent. Further, the circular plug 112, tightly fitted in the cavity 84, provides a support surface for the weight of the tank 12, approximately, evenly distributing the weight of the tank between the plunger and the plug 112. The pony tank is now firmly secured to the buoyancy collar main tank combination in an affirmative locking way. It is precluded from disengaging from the BC-main tank combination due to the affirmative interlocking scheme afforded between the spring-loaded, indexing plunger mechanism 72 and the cylindrically shaped indent 110, irrespective of the spatial orientation of the two tanks, which would be varied in a scuba diving application. The interconnection between the main tank and the buoyancy compensator through the affirmative, cooperative relationship between the spring-biased plunger portion of indexing mechanism 142 and the cylindrically shaped indent 188 ensures the two tanks will not disengage unintentionally from the BC.

When it is desired to separate the pony tank from the main tank, or the main tank from the buoyancy collar, one need to only to urge the plunger 76 of mechanism 72 or its counterpart in mechanism 142, by urging the handle, for example 208 of plunger mechanism 72, axially outward in the direction of arrow 210. This disengages the plunger 76 from the indent opening 110, allowing the separation of the pony tank from the main tank. So also, is the main tank easily disengaged from the buoyancy compensator.

The various angular edges of the pieces described, 20, 22, 24, and 26 can be smoothed by known abrading techniques prior to the engagement of the plunger mechanisms to the respective pieces. This can be important in scuba diving applications.

Of course the location of the individual pieces on a particular cylindrical tank, i.e. piece 20 on tank 12 or piece 22 on tank 10, is somewhat dictated by convenience but also economics. Assuming for the moment that the price of the piece 20 might be somewhat higher due to the fact that a plunger mechanism, a purchased part, would be required, and the fact that a scuba diver might have more pony tanks than perhaps main tanks such as tank 12, it might be preferable to have the less expensive piece, 20, mounted on the pony tank. In terms of operation, other than the relative positioning of the piece with the plunger mechanism above the piece without the plunger mechanism as depicted in FIG. 8, the advantages of the invention are the same and principally turn on the affirmative, quick engagement and disengagement of the two units.

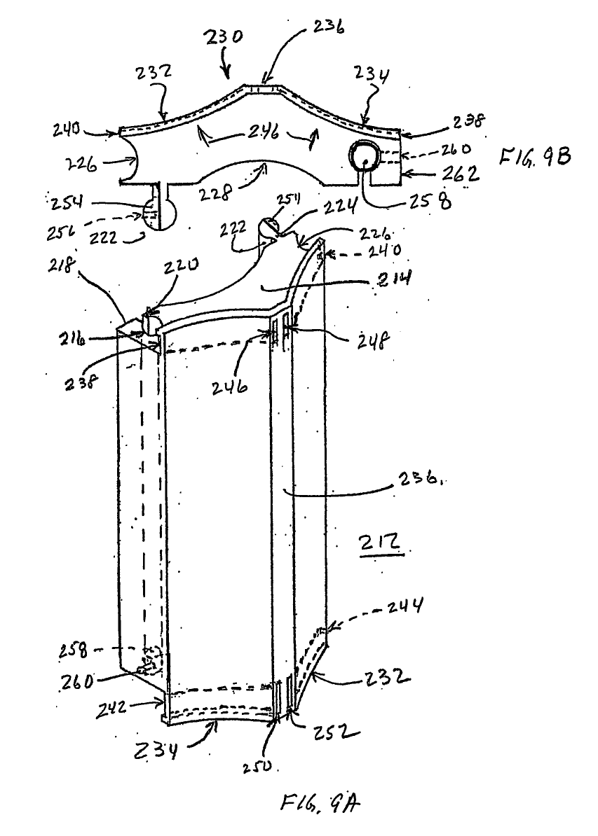

FIG. 9A depicts a piece 212 which cooperates with piece such as 24 to form another adaptation of the invention 14. The piece 212 is first cut to the desired length from a basic formed aluminum extrusion. For a scuba diving tank application, where this piece, 212, is used to mate with piece 24, the length would be approximately 12″ (30.5 cm). Once cut the piece 212 is machined to provide the surfaces and features necessary to implement the invention as to this specific adaptation.

In FIGS. 9A and 9B, the piece 212, as extruded, is seen to include a second central body portion 214. Formed at one lateral end is a cavity 216 which is interiorly disposed in the second central body portion. This cavity is partially circular. The cavity 216 is interconnected along its longitudinal length to and through the surface 218 of the central body portion 214, via a rectangular cutout 220. Formed at the other lateral end by the extrusion is a first, partially circular protrusion 222 extending outward from the second central body portion 214 and connected thereto by extension member 224. The contours of 222 and 224, and their respective dimensions and dimensional relationship to the second central body portion, complement the contours of cavity 216 and cutout 220, and their dimensions, and dimensional relationships to the second central body portion 214, for purposes apparent from the previous discussion.

Arcuate segments 226 and 228 are also formed in the basic extruded piece. These segments are designed into the extruding mold so as to eliminate unnecessary material from the piece, a benefit in scuba diving applications in that it reduces the weight of the piece 212, and helps to minimize drag in the water.

The rear surface 230 of the piece 212 is formed having two partially arcuate surface portions 232 and 234 of predetermined radii. Both surface portions 232 and 234 of rear surface 230 as formed, extend the entire longitudinal length. Each has a radius which complements the radius of the outer surface of a larger cylindrical air tank, such as main tank 10. Of course if there were a need, the surface portions 232 and 234 could be formed to each have the dual radii surface depicted and described in FIG. 6. Or alternately the surface portions 232 and 234 could be formed to each have the radius necessary to accommodate a smaller tank such as tank 12.

Arcuate surface portions 232 and 234 are interconnected in the formed piece by a flat intermediary surface portion 236.

Extending longitudinally, axially, in both directions from the second central body portion 214 are band-clamp retention portions, 238, 240, 242, and 244. Each of the associated facing surfaces as viewed in the direction of arrow 246 are machined to form a retaining groove which is dimensioned to accommodate the longitudinal width and thickness of the securing band portions of a band-clamp such as 42 described above. Slots 246, 248, 250, and 252 are cut through the flat intermediary surface portion 236. This enables respective bands of four associated band-clamps (not shown) to pass along retention portions 238, 240, 242, and 244 and pass through slots 246, 250 and 252. Thus one tank is securely retained against surface 232 and one tank against surface 234.

Circular protrusion 222 is machined on its top end to form a beveled surface 254. As described for piece 26 above, the circular protrusion 222 is further machined to provide a cylindrically shaped indent 256, at a point in the lateral outside surface, just below the end of the beveled surface 254.

As described for piece 26, circular plug 258 is sized to tightly fit at the bottom of cavity 216. It is secured therein via a stainless steel pin 260 which is press-fitted through a compatible opening in the side-wall 262 and into a complementing hole (again, not seen) in the plug 258.

The unit depicted in FIGS. 9A and 9B would be assembled to two tanks, typically two main tanks such as 10, using suitable band-clamps at the top and bottom of piece 212. The BC with piece 24 attached would then be positioned as described above with respect to piece 26. Piece 24 would then be moved to engage piece 212 as described above so as to engage them in an affirmative interlock.

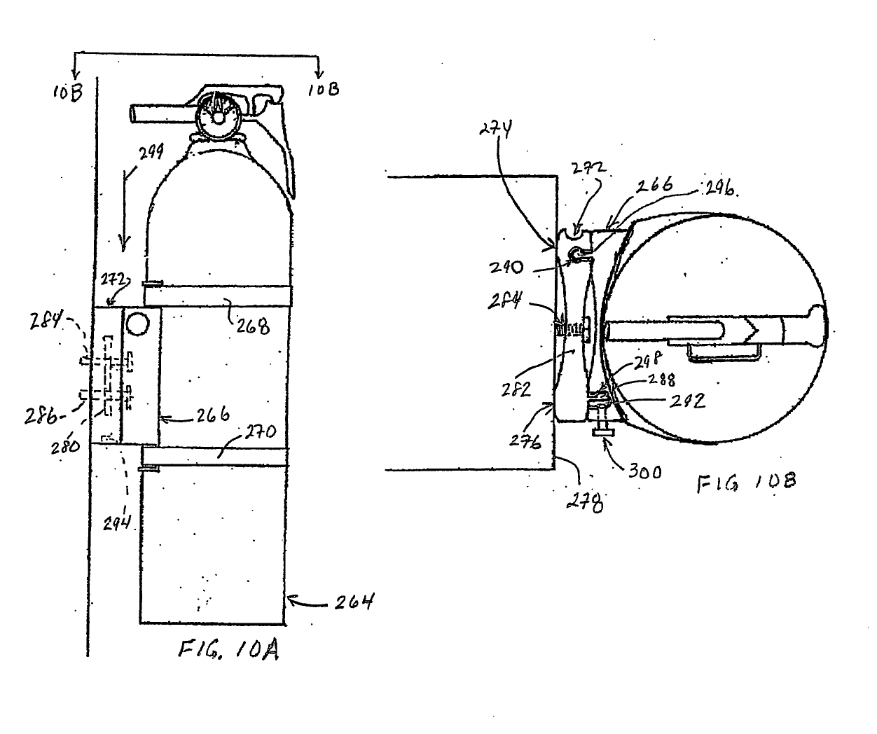

Referring now to FIGS. 10A and 10B, the teachings of the present invention are applied to another application. Here fire extinguisher 264, to which 266 has been affixed by band-clamps 268 and 270, is to be mounted to a vertical surface. Piece 266 is identical in all substantial respects, except, perhaps, for the length, to piece 20. (See FIG. 3). It can be cut from the same extruded basic form from which pieces 20, 22 and 26 are cut.

Piece 272 is formed from the same extruded piece used to fashion piece 24, (see FIG. 5). However, the basic extruded piece is machined differently to accommodate this particular application. So for example, the piece 272 retains the formed flat surfaces 274 and 276 which facilitate its mounting to the vertical surface 278. Further, the piece 272 is machined to include at least one opening, which could be a slot 280, to accommodate bolts 284 and 286 used to secure the piece 272 to the vertical mounting surface. As illustrated, the bolts 284 and 286 pass through the slot in the piece 272. The piece 272, since made from the same basic extruded piece as piece 24, includes a circular portion 288 and a cylindrical cavity 290. Here, however, the circular portion extends the full length of the piece 272 and reflects the configuration of circular portion 90 of FIG. 4. I.e., circular portion 288 is further machined to include a beveled surface 292 and a cylindrical indent (not seen) just below the beveled surface where it meets the lateral side of the circular portion at a location identical to the location of cylindrical indent 110 on circular portion 90 as seen in FIG. 4. Further, the piece 272 is different from the piece 24, in that a circular plug 294 is positioned in cavity 290 at the bottom, similar to circular plug 112 positioned in cavity 84 in piece 22 as seen in FIG. 4. The plug is tightly fit into the cavity and secured by an appropriate pin, again as disclosed above with respect to FIG. 4.

Once piece 266 is secured to the fire extinguisher 64, and the piece 272 secured to the vertical mounting surface 278, the user mounts the extinguisher to the surface by axially aligning circular portion 296 and cavity 298 of piece 266, with the corresponding cavity 290 and circular piece 288 of piece 272. Once aligned, the user would lower the fire extinguisher down onto the piece 272 in the direction of arrow 299. When the plunger in the mechanism 300 contacts the beveled surface 292 it is urged back into the housing of mechanism 300 as described above. When the plunger portion is opposite the cylindrical indent (again, not seen) such as indent 110 in FIG. 4, the plunger is urged into the cylindrical indent by the spring in the housing. At this point the shortened cylindrical portion 296 rests on the top of the circular plug 294 to provide a balanced distribution of weight between the plug and the plunger portion of the mechanism 300. To remove the extinguisher, the user would simply retract the plunger by the pulling outwardly on the handle of mechanism 300, and then lift the extinguisher out of the interconnecting relationship between piece 266 and 276.

It should be apparent, at this juncture, that the present invention has broad application to the mounting of various devices in a secure, quick and convenient way so that the item to be mounted can be easily removed. It is apparent that this could have application to the mounting of expensive electronic gear, on board ships as well as other items referred to above.

While the present invention has been disclosed in connection with versions shown and described in detail, various modifications and improvements will become readily apparent to those skilled in the art. Accordingly, the spirit and scope of the present invention is to be limited only by the following claims.

What is claimed is:

1. A system for mounting and dismounting at least two items, comprising:
(a) a first piece and a second piece, said first piece for being affixed to a first item, and said second piece for being affixed to a second item;
(b) said first piece having a top and a bottom, left and right sides, and a front and rear surface, said front surface of said first piece having a first protrusion extending longitudinally from said top of said first piece to a spaced distance from said bottom of said first piece along one side, said front surface having an internally disposed first cavity extending longitudinally from said top to said bottom of said first piece along a side opposite said first protrusion;
(c) said second piece having a top and bottom, left and right sides, and a front and rear surface, said front surface of said second piece having a cooperatively matching second protrusion extending longitudinally from said top of said second piece to a spaced distance from said bottom of said second piece along one side, said second protrusion being dimensioned for sliding within said first cavity of said first piece, and said front surface of said second piece having a cooperatively matching second cavity for accepting said first protrusion in a sliding relationship extending longitudinally from said top to said bottom of said second piece along a side opposite said second protrusion;
(d) said first and second pieces having cooperative means for automatically positioning and automatically locking said first and second pieces together, so that when said first piece is affixed to said first item, and when said second piece is affixed to said second item an operator can cause said first item to be mounted onto said second item by sliding said first cavity on said first piece over said cooperatively dimensioned second protrusion on said second piece while simultaneously sliding said first protrusion on said first piece into said cooperatively dimensioned second cavity on said second piece, said first and second piece automatic positioning means and automatic locking means thereby connecting said first and second pieces together in a secure, mounting relationship.

2. The system according to claim 1 wherein said first and second protrusions on said first and second pieces are partially circular protrusions extending outwards from said respective front sections and connected to said front sections via respective extension members, and wherein said first and second cavities are each partially circular and interconnected along their respective lengths to said front surfaces via rectangular cut-outs in each of said front surfaces.

3. The system according to claim 1 wherein said automatic locking means in said first and second pieces includes a spring loaded, indexing plunger mechanism having a displaceable handle affixed to said first piece along a longitudinal length of said first piece, said plunger mechanism having a spring-biased plunger portion extending laterally into said first cavity; and, a beveled top surface on said second protrusion, said second protrusion further having an indent immediately below said beveled surface, so that when said operator mounts said first piece onto said second piece said spring-biased plunger portion of said plunger mechanism contacts said top beveled surface of said second protrusion, thereby forcing said spring-biased plunger portion back into said plunger mechanism until said indent in said second protrusion and said spring-biased plunger portion are in axial alignment, said spring-biased plunger portion being dimensioned so as to slide into said indent, said spring-biased plunger portion then being urged into an engagement position with said indent by said spring loaded plunger mechanism, thereby affirmatively locking said first piece and said second piece in said secure, mounting relationship.

4. The system according to claim 3 wherein said automatic positioning means in said first and second pieces is a plug affixed at a bottom area of said second cavity in said second piece, and a cooperatively dimensioned first protrusion having a predetermined length, so that when said operator mounts said first piece onto said second piece said first protrusion is caused to stop in said second cavity at a position at which said indent in said second protrusion is in axial alignment with said spring-biased plunger portion of said spring loaded plunger mechanism, thereby automatically positioning said first piece and said second piece for said automatic locking of said first piece and said second piece in said secure, mounting relationship.

5. The system according to claim 3 wherein after said automatic locking of said first piece to said second piece, said two pieces can be dismounted by an operator by displacing said handle so as to disengage said plunger portion from said engagement position, and then lifting said first piece free of said second piece.

6. The system according to claim 1 wherein said first piece is connected to said first item by at least one band-clamp, and said second piece is connected to said second item by at least one band-clamp.

7. The system according to claim 6 wherein said first piece and said second piece have retaining groves dimensioned to accommodate a longitudinal width and thickness of a securing band portion of said at least one band-clamp.

8. The system according to claim 1 wherein said first piece and said second piece are fabricated from a longer piece of extruded aluminum.

9. The system according to claim 1 wherein said rear surface of said first piece and said rear surface of said second piece have partially arcuate surfaces of a predetermined radii substantially matching cylindrical surfaces of items for attachment, such as air tanks.

10. The system according to claim 9 wherein at least one of said first piece and second piece have two different partially arcuate surfaces on said rear surfaces of predetermined radii substantially matching cylindrical surfaces of two different items for attachment, such as two tanks of differing diameters.

11. The system according to claim 9 wherein at least one of said first pieces and said second pieces has two opposed partially arcuate surface portions extending a complete longitudinal length of said rear surface of predetermined radii substantially matching cylindrical surfaces of two tanks for attachment, said two opposed partially arcuate surfaces being angled towards one another so as to permit a cooperative mounting of said first or second protrusions and said first or second cavities on said front surfaces with a front surface of another first or second piece.

12. The system according to claim 1 wherein said rear surface of said first piece and/or said rear surface of said second piece has at least a partial flat surface for attachment to items having a flat surface.

13. The system according to claim 12 wherein said front surface and said rear surface have at least one confluent aperture therethrough for allowing a nut and bolt combination to secure said first piece and/or said second piece to said flat surface of said item.

14. The system according to claim 1 wherein said first piece is affixed to a pony air tank.

15. The system according to claim 1 wherein said second piece is affixed to a main air tank.

16. The system according to claim 13, further comprising a pair of first pieces wherein one of said pair of first pieces has a rear surface having a partially flat surface, and the other of said pair of first pieces having a partially arcuate rear surface, and a pair of second pieces each having a pair of partially arcuate rear surfaces, each one of said second pieces being attached to a main air tank via band-claims, said partially arcuate rear surfaced first piece being attached to a pony air tank via band-claims, said partially flat rear surfaced first piece being attached to a buoyancy compensator via a nut and bolt combination, so that said operator can lift said partially flat rear surfaced first piece on said buoyancy compensator over one of said pair of second pieces on said main air tank and mount said buoyancy compensator to said main air tank, and said operator can lift said partially arcuate rear surfaced first piece over a second one of said pair of second pieces on said main air tank and mount said pony air tank to said main air tank, thereby creating a secure, mounting relationship between said buoyancy compensator, said main air tank, and said pony air tank.

17. The system according to claim 13 wherein said first piece is affixed to a cylindrically shaped fire extinguisher, and said second piece is affixed to a wall, so that said operator can lift said first piece on said fire extinguisher over said second piece on said wall and thereby mount said fire extinguisher to said wall.
